(19) United States
(12) Patent Application Publication
(10) Pub. No.: US 2008/0272142 A1
(43) Pub. Date: Nov. 6, 2008

(54) Article Dispenser

(76) Inventor: Munroe Chirnomas, Morris TWP., NJ (US)

Correspondence Address: LAWRENCE C. EDELMAN, IP COUNSEL FASTCORP, 60 E. HANOVER AVE, B-2, MORRIS PLAINS, NJ, 07950, US

(21) Appl. No.: 11/915,516

(22) PCT Filed: May 25, 2006
(86) PCT No.: PCT/US2006/020487

§ 371 Date: Nov. 26, 2007

Related U.S. Application Data
(60) Provisional application No. 60/684,501, filed on May 25, 2005.

(51) Int. Cl. G07F 9/10

(52) U.S. Cl. 221/282

(57) ABSTRACT

An article dispenser where the structure of an article storage cabinet positioned inside the article dispenser, is used to supplement the structure of at least two sidewalls used to form a housing for the article dispenser. In one preferred embodiment where the article storage container comprises a chest freezer or refrigerator, sidewalls used to form the housing for the dispenser are connected to the top or sidewall structure of the chest freezer or refrigerator for receiving structural support.

### CROSS-REFERENCE TO RELATED APPLICATIONS

This application claims priority under 35USC 120 of my earlier filed U.S. Provisional Patent Application U.S. Ser. No. 60/684,501, filed May 25, 2005, entitled “Low-Cost Article Dispenser”. The entire disclosure of this patent application is incorporated herein by reference in its entirety.

### FIELD OF THE INVENTION

The present invention relates to a new method and apparatus for making an article dispenser

### SUMMARY OF THE INVENTION

An article dispenser where the structure of an article storage cabinet positioned inside the article dispenser, is used to supplement the structure of at least two further sidewalls used to form a housing for the article dispenser. In one preferred embodiment where the article storage container comprises a chest freezer or refrigerator, sidewalls used to form a top portion of the housing for the dispenser are connected to the top or sidewall structure of the chest freezer or refrigerator for receiving structural support.

The present invention avoids the need for a more traditional vending machine cabinet or housing which typically houses the article storage area and the article dispensing mechanism therein. More specifically, in for example a dispenser, such as a vending machine for refrigerated or frozen articles, the article storing chest freezer or chest refrigerator portion of the vending machine comprises the base which is used to support an article dispensing mechanism and related dispensing mechanism housing thereabove.

### BRIEF DESCRIPTIONS OF THE DRAWINGS

The accompanying drawings, which are incorporated herein and constitute part of this specification, illustrate embodiments and details of the invention, and, together with the general description given above and the detailed description given below, serve to explain the features of the invention.

FIG. 1 illustrates a package vendor of the type described in my issued U.S. Pat. No. 5,240,139, which is useful for understanding the environment of the present invention.

FIGS. 2 and 3 illustrate side and perspective views, respectively, of an article storage unit of the type useful for understanding the environment of the present invention, which article storage unit comprises as a chest freezer or chest refrigerator of a type similar to that shown in the embodiment of FIG. 1, however with the thermal separating door being of a different type.

FIGS. 4 and 5 illustrate perspective and front views, respectively of an article dispenser in accordance with the principles of the present invention.

FIG. 6 illustrates an air barrier arrangement which can be used in addition to or in place of the thermal door with is shown in FIGS. 1 and 2.

FIG. 7 shows a further embodiment of the invention.

### DETAILED DESCRIPTION OF THE DRAWINGS

### Prior Art

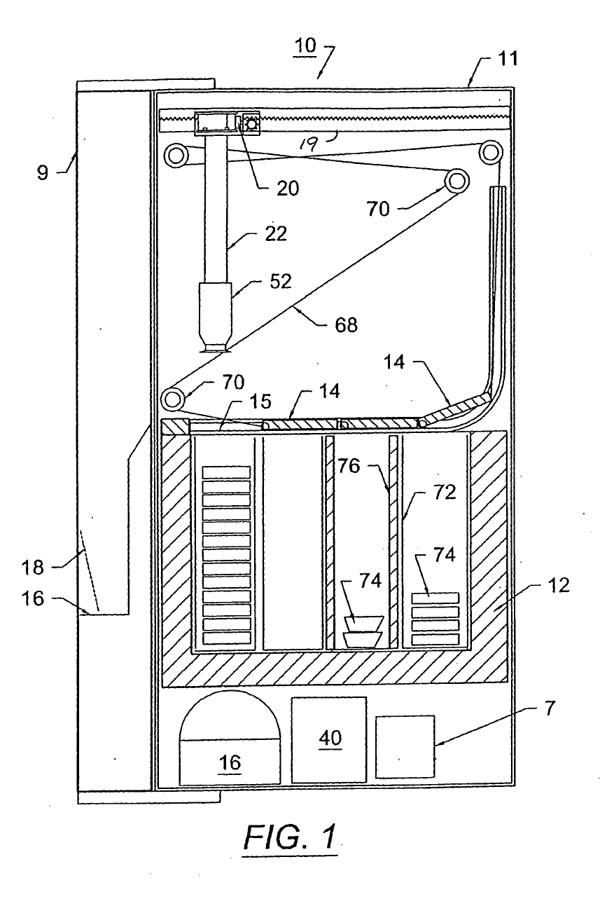

FIG. 1 illustrates a package vendor or vending machine of the type described in previously issued U.S. Pat. No. 5,240,139, which is useful for understanding the environment of the present invention. Typically, this vendor is used for chilled and/or frozen food items, such as ice cream bars, or other ice cream products, food items, such as breakfast sandwiches, beverages or other food and non-food type products. The vendor or vending machine 10, as well known, comprises an outer housing 11 commonly referred to as a vending machine cabinet, typically constructed of sheet metal, which is formed into an appropriate shape, having a rear wall, top, left and right walls and a cabinet base which are usually welded together so as to form an inner cavity, which inner cavity holds in its lower half a suction generator 40, a control mechanism 7 and a chest freezer 12 (where freezer 12 can include in its bottom portion a compressor 16). The vending cabinet 11 is an independent structure which is designed to stand on its own and be structurally rigid independent of the items within it, such as the chest freezer structure, so that one could remove the chest freezer entirely from the vending machine cabinet, for example by removing a few screws and electrical connections, to as to remove the chest freezer, and the vending machine cabinet would still maintain, without diminishment, its original structural integrity and rigidity. Mounted in the upper half of the interior of housing 11 are the components of an article retrieval apparatus, which in this particular case comprises a suction hose 22, which is positionable along a slide arrangement 19 to various locations inside the cavity by use of computer controlled motors 20, so that the article suction cup pick-up head 52 becomes aligned with a given column 72 inside the freezer 12. The columns 72 have stored therein articles 74, and the column 72 to which the head 52 is aligned with is the one that stores therein an article of the type that has been selected by a user of the vendor. The user makes the article selection using an article selection keypad and payment system, which systems are well know and therefore in the interest of clarity are not shown herein. The columns 72 are refilled with articles to be vended by opening a hinged front door 9 that covers an access opening into housing 11. FIG. 1 also shows the use of a thermal separator, i.e., a sliding door 14 operated by a cable 68 threaded-over rollers 70, that is used to open and then close the freezer, i.e., uncover and then cover opening 15, when the vendor is asked to dispense a product. When the article is dispensed, the pick-up head deposits it in a customer retrieval area/chute 16, where the user can obtain it after moving an optionally included hinged door 18.

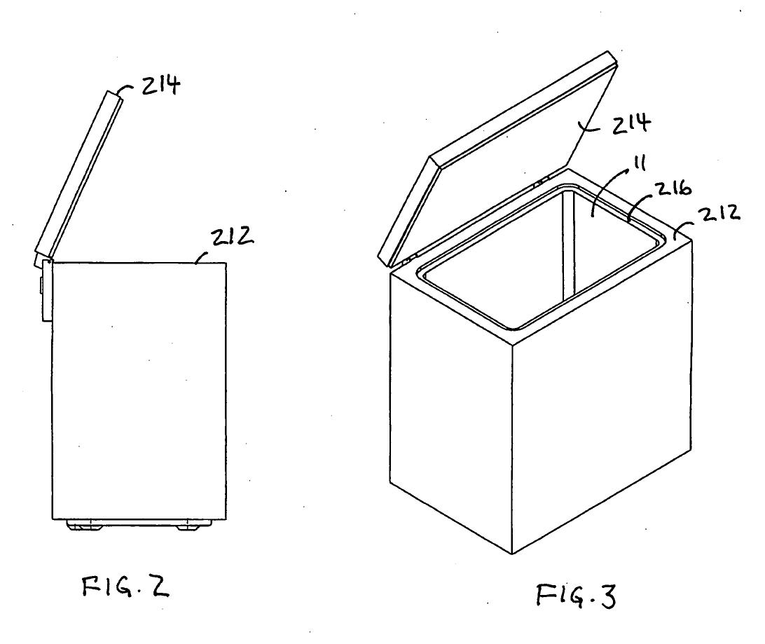

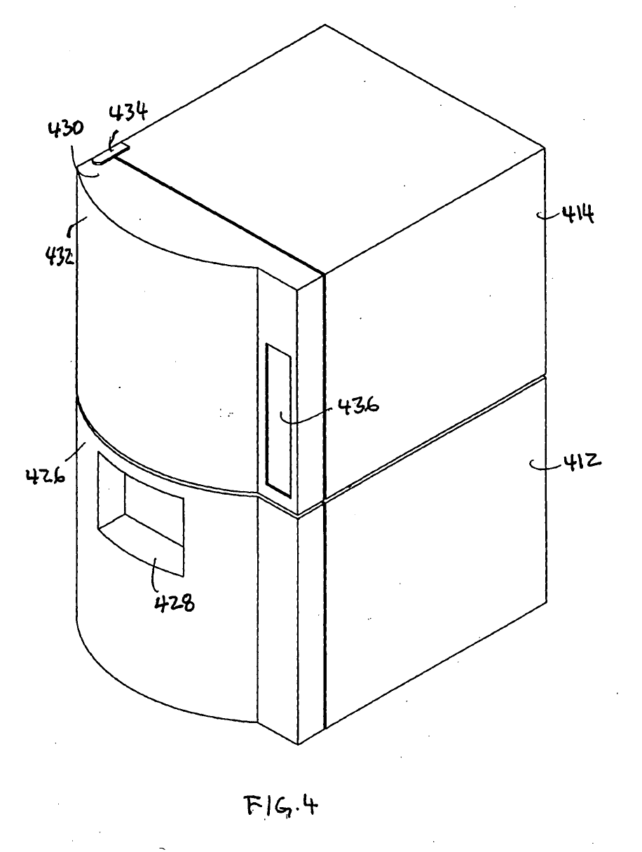

FIGS. 2 and 3 illustrate side and perspective views, respectively, of a known freezer 212 of the type similar to that shown in the embodiment of FIG. 1, with the door 14, however, being of a different type. In the FIGS. 2 and 3 embodiment, door 14 is replaced by a door 214 comprising a one-piece horizontal lid which is hingedly mounted at the rear portion of freezer 212 so as to open/close to selectively provide access to the top opening 11 of the freezer. Other types of storage container or chest freezer doors, such as sliding doors could also be used instead of the door 14 of FIG. 1. A recess 216 that surrounds opening 11 can be used to support an air barrier arrangement as shown in FIG. ?(which is of the type shown in published U.S. Ser. No. 10/654,361, publication number 20040079761), such as a flexible sheet having a plurality of flaps cut therein, so as to allow passage of articles therethrough during dispensing. Such a flexible sheet barrier could be used in addition to or in place of a thermal door of the type shown in FIG. 1 or 2.

In an arrangement such as this, the housing or vending machine cabinet is a significant expense, relatively complex to manufacture and requires significant manufacturing resources in order to manufacture in large quantities. It would be desirable to provide a method and apparatus for a low-cost vending machine and related housing which is faster and easier to manufacture and which requires less manufacturing infrastructure to produce.

### The Invention

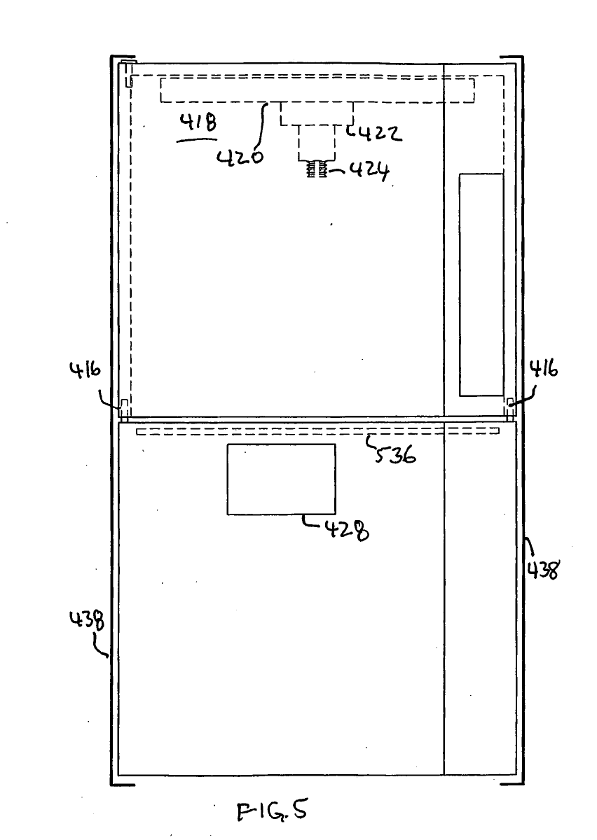

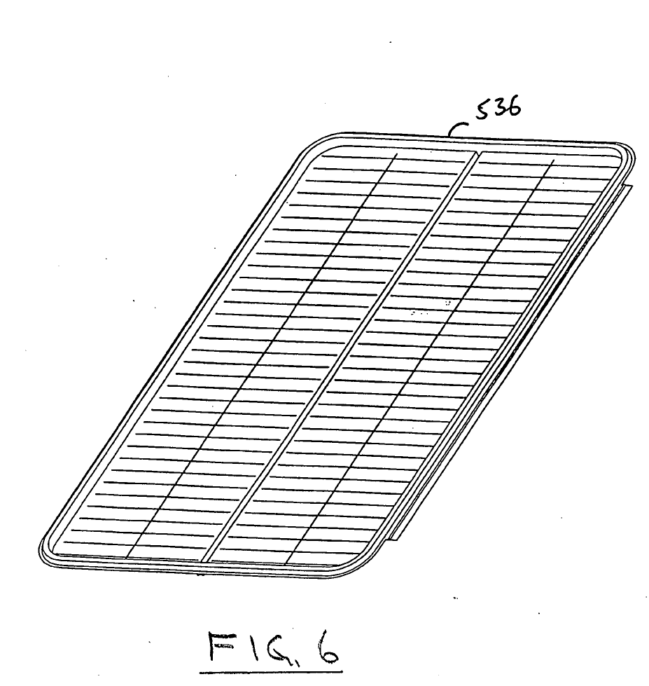

In accordance with the principles of one embodiment of the present invention, FIGS. 4 and 5 illustrate perspective and front views, respectively, of an article dispenser which includes no overall cabinet or housing for forming an internal cavity in which to hold therein and mount thereon the conventional components, such as a chest freezer, of a dispenser or vendor. The components of the new vendor are basically a storage area 412 (essentially the same as 212 in FIGS. 2 and 3) which can be a chest freezer (or a chest refrigerator or even a chest container) which forms a base for the vendor, and a hood or “cap” portion 414 which basically provides the function similar to the top portion of the conventional vending machine cabinet/enclosure which is designed to house or otherwise contain therein the dispensing mechanism and other components of the apparatus. The sidewalls of the cap 414 do not need to extend to the ground, and the weight of the cap is at least partially supported by the top portion and sidewalls therebelow, of freezer 412. Pins 416 shown in dashed lines in FIG. 5 may be used to help align and maintain alignment between freezer 412 and cap 414. The cap and chest freezer (or storage container) can be connected together by various methods or means including screws, bolts, clamping devices and or an adhesive or other method. Furthermore, the cap and container can be connected in such a way, for example, using adhesives so as to create a relatively permanent connection which can be designed to be specifically separable or inseparable at some date after initial manufacture. In this embodiment the outer side and rear walls of the chest container 412 may be fully exposed to the end customer since they help to form the lower portion of the overall housing which is formed when the cap and chest are connected together. Therefore, with the addition of front door 430 and front lower housing 426 the aesthetic appearance from the outside will be similar to a typical full height, proportioned and/or sized vending machine. In the illustrated embodiment, the robotic dispensing mechanism 418, comprising a slide apparatus 420, carriage 422 and suction hose/pick-up head 424, is a functional equivalent to what is shown in FIG. 1, however any dispensing arrangement could be used, and it could be supported by the roof (top wall) of cap 414, a side wall of cap 414, or even the rear portion of the top portion of freezer 412. Alternatively, the robotic dispensing mechanism 418 or other type of retrieval or dispensing apparatus can be mounted directly on top of the walls or other structure of the chest freezer 412 and the weight or load of the mechanism 418 can be fully or partially supported by the chest freezer or article storage container 412.

In order to provide the similar but additional functions of the front access/loading door of 9 as shown in FIG. 1, in this illustrated embodiment, a split arrangement can be provided, where a conventional bubble front 432 of FIG. 4 including a customer retrieval area 428 can be attached in a fixed or hinged manner to the front of the freezer chest or storage container, and made to look like the bottom half of a conventional vending machine door within the lower front housing 426, and the top half, is actually a hinged door 430, that functions substantially the same as the more typical vending machine door 9 in FIG. 1. Thus, the top half includes, for example, a metal door frame 430 hingedly mounted (434) to the cap 414. The frame 430 has a conventional bubble front 432 mounted thereon and has an opening 436 therein which is adapted to allow access to the user of the vending machine of the conventional user accessible components, such as a product selection keypad, as well as a payment system and coin return (such components are not specifically shown). An operator of the vending machine, can open the door 430 to fill the freezer 412 in a conventional manner. The bubble front in the top half could also have “windows/boarders” graphically formed thereon, so that individual product selection graphic cards could be inserted behind the bubble, as is done in the bubble front of a conventional vending machine.

The front lower housing portion 426 can be designed to house a retrieval port 428 to enable customers to retrieve dispensed products. Furthermore, the front lower housing can house the vacuum blower or pump system, the machine control system, payment and currency handling equipment, lighting fixtures and or an assortment of other components. The lower front housing can be designed to open as a door which is hinged or mounted in some other similar fashion. Furthermore, the front lower housing can be designed to be fixed with hardware and or adhesive bonding to the side wall of the storage container or chest freezer, thereby giving the unified aesthetic appearance of a full sized traditional vending machine, but whereby the complexity and cost of the apparatus is reduced. Furthermore, the front lower housing and any of the items housed therein can be designed to have be partially or fully connected to and or structurally supported by the structure of the storage container or refrigerated chest.

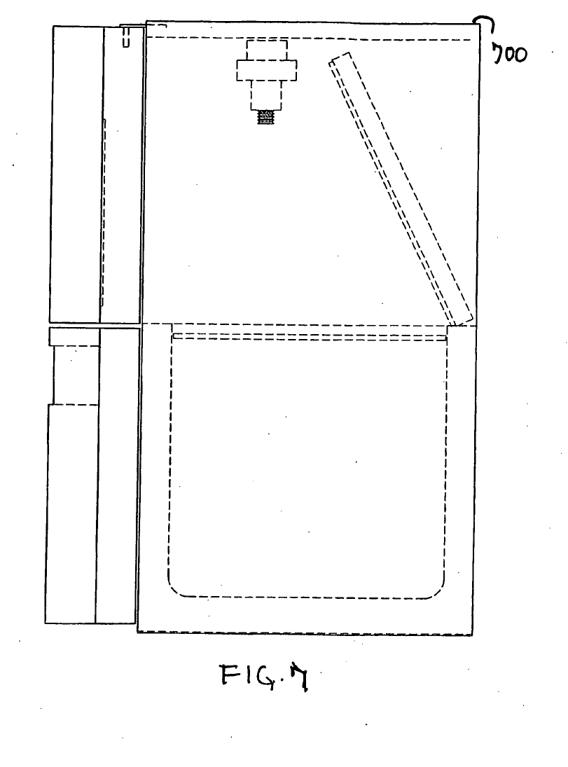

It is noted that a lid similar to lid 214 of FIGS. 2 and 3 may be used herein, or if a just a thermal barrier of the type noted above as shown in my published U.S. Ser. No. 10/654,361, publication number 20040079761), maybe used, as shown by dashed lines 536 (see also 536 of FIG. 6). If a large one-piece hinged lid is not used, the freezer may be much taller, or alternatively, the height of the cap can be reduced.

An additional feature that can be used with the present invention is the use of “side panels” 438, as shown in FIG. 5. Such panels can be used for purely aesthetic reasons, to make the low-cost vending machine have the same form factor and appearance as a traditional vending machine, by eliminating the appearance of a horizontal seam between the upper portion and lower portion of the machine which might other wise be revealed at the point where the chest and the cap meet, and could, in addition, in accordance with a further aspect of the invention, provide extra structural support and/or rigidity to the vendor apparatus by structurally further connecting or bonding the cap 414 with the chest 412. Such support can be purely support to prevent side to side movement of the cap relative to the freezer, but it could also be used to proved support for the cap in the vertical direction, that is, against gravity. In this case, panels 438 could include some kind of tab or ridge that would fit in the space between under the cap and above the top of the freezer, to help shoulder the load of the cap, in order that the load doesn't have to be carried 100% by the freezer, or alternatively the side panels could be formed with flanges in the front, rear top and or bottom of the machine so as to provide further structure to the entire assembly. The panels can be formed of sheet metal or other materials and can be connected to the other parts of the assembly using hardware and or adhesive which could be used to bond the panels to the surfaces including the side walls of the cap and or the chest storage container.

Furthermore, the panels could be made of a non-painted material such as a galvanized material and then can have large graphic stickers adhered to them for aesthetic and environmental protection purposes.

In a further embodiment, such as shown in FIG. 7, panels 700 forming an enclosure having a top, a rear and side walls and made of materials such as sheet metal can be combined in a fashion more similar to a conventional vending machine cabinet. In this embodiment, the sides of the cabinet 700 could be the full height of the machine and can be connected or bonded to the outer surfaces of a chest freezer, chest refrigerator or structural container. In this embodiment, the bottom outer wall of the chest can form the bottom floor of the machine cabinet, or alternatively there can be a more traditional vending machine base plate which is connected to the side and rear walls of the sheet metal enclosure and which forms the bottom of the cabinet. In this embodiment, the cabinet structure can be made using lighter gauge materials and or fewer structural elements than a traditional cabinet and can instead rely upon the rigidity which is created by bonding the sheet metal panels to the outside of the freezer chest walls. In this design, the chest freezer plays such an integral role in creating structural rigidity of the overall cabinet that if one were to try and build a similar cabinet without including the chest or container as part of the structure, the cabinet would have significantly less rigidity and or structural integrity and most likely not be able to perform as required. Thus, the freezer becomes an integral component of the cabinet structure. The use of adhesives which can be conductive can also be useful to bond the outer walls of the freezer to the sheet metal panels, since this will allow the heat dissipated by the condenser outer walls of the freezer system to conduct and dissipate through the walls of the outer cabinet. Level legs or other machine legs can be connected to the freezer bottom, the cabinet bottom or both bottoms.

While the present invention has been disclosed with reference to certain embodiments, numerous modifications, alterations and changes to the described embodiments are possible without departing from the sphere and scope of the present invention, as defined above. For example, it is clearly not necessary that the article storage area comprise a freezer, or for that matter that it have any thermal properties. It merely must have walls to define a storage area and at least partially support the cap and or the outer cabinet walls. Similarly, although the article retrieving device is shown to use a controllably positioned suction hose and pick-up head, other types of article retrieving devices that enter a storage area to retrieve a product could be used, for example one using a claw, other grasping end effecter or other more traditional dispensing devices. The above described invention can also be used to make a merchandising cabinet for products whereby there is no automatic dispensing mechanism and whereby the removal of products are done manually. Accordingly, it is intended that the present invention not be limited to the described embodiments, but that it has the full scope suggested by the above-language, as well as equivalents thereof.

1. An article dispenser, comprising:
an article storage container having a base, upwardly projecting side walls and an open top, said article storage container providing an article storage area for said article dispenser, and said article storage container also functioning as a structural member for providing a bottom portion for the article dispenser, and
a cap structure having a top, downwardly projecting side-walls, and an open bottom, wherein
said cap structure is positioned on top of the article storage container in a manner so that the open top of the article storage container opposes the open bottom of the cap structure, with the structure of the article storage container at least partially supports the weight of the cap structure,
the cap structure includes therein an article dispensing mechanism, and wherein
the cap also includes a door mounted thereon and operable so as to provide access to the interior of said cap structure.

2. The article dispenser of claim 1, where the article storage container is a chest freezer.

3. The article dispenser of claim 1, where the side-walls of the article storage container support the cap structure.

4. The article dispenser of claim 1, where a top portion of the article storage container supports the hood structure

5. A vending machine, comprising:
a) a cap,
b) a storage chest, the cap being positioned so as to cover the chest, and
b) panels which cover a seam between the cap and the chest so as to present the visual appearance of a unified structure
